(19) United States
(12) Patent Application Publication
(10) Pub. No.: US 2024/0404405 A1
(43) Pub. Date: Dec. 5, 2024

(54) Method And Assistance System For Parking Support By Means Of A Hybrid Map, Corresponding Digital Hybrid Map, And Correspondingly Configured Motor Vehicle

(71) Applicant: Volkswagen Aktiengesellschaft, Wolfsburg (DE)

(72) Inventors: Philipp Hüger, Rühen (DE); Michal Kovarik, Praha 10 (CS); Jens Arik Almkermann, Edemissen (DE)

(73) Assignee: Volkswagen Aktiengesellschaft, Wolfsburg (DE)

(21) Appl. No.: 18/734,456

(22) Filed: Jun. 5, 2024

(30) Foreign Application Priority Data
Jun. 5, 2023 (DE) 10 2023 205 241.5

(51) Int. Cl. G08G 1/14; G01C 21/36; G06V 10/10; G06V 20/13; G06V 20/58

(52) U.S. Cl. CPC G08G 1/141; G01C 21/367; G01C 21/3685; G06V 10/16; G06V 20/13; G06V 20/586

(57) ABSTRACT

The disclosure relates to a method and an assistance system for supporting a vehicle driver when parking a vehicle. A mosaic image is composed of image parts of various camera images depicting free parking spaces and shows an area comprising multiple parking spaces exclusively with free parking spaces. According to a current occupancy of the parking spaces captured by sensors, corresponding labelings are then overlaid over this mosaic image to generate a corresponding hybrid map of the area. This hybrid map is then provided to support the vehicle driver. The disclosure also relates to such a hybrid map and to a correspondingly configured motor vehicle.

### CROSS-REFERENCE TO RELATED APPLICATIONS

This application claims priority to German Patent Application No. DE 10 2023 205 241.5, filed on Jun. 5, 2023 with the German Patent and Trademark Office. The contents of the aforesaid patent application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The present disclosure relates to a method and an assistance system for supporting a vehicle driver when parking a vehicle. The disclosure furthermore relates to a corresponding digital map for realizing this support and to a correspondingly configured motor vehicle.

Parking a vehicle, i.e., for example, parking a motor vehicle in a parking lot or the like, can be a challenging task for many drivers. For example, difficulties can involve finding a free and suitable parking space and maneuvering the vehicle in question on the way there. To support the driver, there are already systems called parking assistants that, for example, output a signal when driving past a free parking space, sometimes supported by a schematic graphical representation of the environment. However, it has been shown that it can be difficult for drivers to identify a free parking space found automatically by a corresponding assistance system in the real environment. In addition, drivers may have additional requirements for a parking space, which have not been taken into account by previous systems. With this in mind, there is therefore further need for improvements when supporting a vehicle driver when parking a vehicle.

### SUMMARY

A need exists to provide a particularly simply understandable support for a vehicle driver when parking a vehicle.

The need is addressed by the subject matter of the independent claim(s). Embodiments of the invention are described in the dependent claims, the following description, and the drawings.

### BRIEF DESCRIPTION OF THE DRAWINGS

FIG. 1 shows a schematic representation of a series of example camera images of a parking lot recorded at different points in time;

FIG. 2 shows a schematic representation for illustration of an example recording of local environment data in the parking lot corresponding to the recording of the camera images;

FIG. 3 shows a schematic representation of an example mosaic image of the parking lot composed of the camera images;

FIG. 4 shows a schematic representation of another example mosaic image of a parking lot;

FIG. 5 shows a schematic representation of an example hybrid map of the parking lot generated using the additional mosaic image, with overlays for labeling occupied and free parking spaces; and

FIG. 6 shows a schematic representation of an example motor vehicle and an example vehicle-external server apparatus for supporting a driver when parking the motor vehicle with the aid of a hybrid map of a parking lot.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In the embodiments described herein, the described components of the embodiments each represent individual features that are to be considered independent of one another, in the combinations as shown or described, and in combinations other than shown or described. In addition, the described embodiments can also be supplemented by features other than those described.

In some embodiments, a method serves to support a vehicle driver when parking a vehicle in a parking space that is located in an area with multiple such parking spaces. The vehicle driver can therefore, for example, be a driver who wishes to park a motor vehicle, wherein the parking space can be, for example, a parking spot, a parking space, a carport, or the like. The area with multiple such parking spaces can accordingly be, for example, a parking lot or a row of parallel parking spaces or a parking area on private property or the like. However, the method in some embodiments can also be applied, for example, for aircraft traveling on the ground, i.e., for instance, in the area of an airport with multiple parking spaces for airplanes or the like, or for ships and/or boats, for instance in a harbor or mooring area with multiple individual mooring or docking spaces or the like.

In some embodiments, multiple camera images of the area are recorded at different points in time, at which different occupancies or, respectively, occupancy patterns of the parking spaces by vehicles are present, i.e., correspondingly different occupancy situations of the area or, respectively, of the parking spaces. These camera images are recorded in a period of time that is temporally before, i.e., preceding, the parking of the vehicle, i.e., for example, a point in time or period of time in which the vehicle is controlled by the vehicle driver toward or in the area with the intention of parking the vehicle. For example, the multiple camera images can be recorded over a period of time of multiple hours, multiple days, multiple weeks, or multiple months or the like. For example, when recorded on different days, the camera images can be recorded at least substantially at the same time of day or at the same position of the sun or, respectively, the same weather conditions or lighting conditions. This allows later artifacts to the avoided or reduced.

The camera images can be recorded for example as aerial images and/or satellite images and/or by means of a vehicle camera of a vehicle located or moving in the area, for example, by means of what is called a top-view camera. For example, a camera permanently installed in or on the area and oriented toward the area can also be used as the camera for recording the camera images. This can be, for example, a surveillance camera for the area. Such a permanently installed camera can be arranged for example at a position that is elevated relative to the actual surface of the area, for example on a building on or next to the area or on a pole or the like.

For further processing and in some embodiments, the camera images can then be sent via a corresponding data connection to, for example, a server apparatus, i.e., for instance a backend, a cloud server, or a data center or the like, or, respectively, collected or aggregated there.

In some embodiments, those image parts showing free parking spaces, i.e., those that are not occupied by a vehicle, are extracted from these recorded camera images—also temporally before the parking —and are combined to form a mosaic image of the area. This mosaic image then shows the entire area with exclusively free parking spaces. The mosaic image can therefore show, depending on the design of the area in question, for example, free parking spaces and parts of the area arranged next to or between them, but not occupied parking spaces. In other words, the mosaic image can therefore be formed or composed, for example, by means of what is called a stitching method. The parts of the image that are used for this, which each show, i.e., depict, for example, at least one free parking space, can originate from multiple camera images, in particular ones recorded at different points in time, and can be combined with each other to form the mosaic image. The mosaic image is therefore not an individual image of the area actually recorded as such at a single specific point in time but is instead formed from actually recorded image points or, respectively, image parts from the recorded camera images. This means the mosaic image can therefore look or appear, for example, like a camera image, in particular an aerial image or satellite image, that was recorded at a point in time at which all parking spaces in the area were free, even if this was not actually the case at any specific point in time. The mosaic image therefore shows the actual real area as a photographic representation and in particular does not show an abstracted or schematic map of the area.

In some embodiments, environment data of at least one part of the area, in particular next to the vehicle, are recorded by means of at least one sensor when the vehicle is located in or on the area for parking, which data display or characterize a current occupancy or, respectively, occupancy situation of the parking spaces there in each case. These environment data can be recorded in particular by means of a sensor or, respectively, sensor system of the vehicle itself. However, the environment data can also be recorded, for example, by means of a sensor permanently installed, for example, locally in or on the area, i.e., an infrastructure sensor. Such an infrastructure sensor can be embedded or integrated, for example, into the area, i.e., for instance into the ground or pavement there or the like, or can be arranged, for example, at an elevated position and oriented toward the area, for example in the form of a surveillance camera or the like. A corresponding combination is also possible, wherein the environment data then originate or, respectively, are recorded, for example, partially by a sensor of the vehicle and partially by an infrastructure sensor. This allows, for example, a verification or plausibility check of the recognition or, respectively, identification of the current occupancy to be performed.

The current occupancy can indicate in each case which of the parking spaces are occupied and/or which of the parking spaces are free, i.e., not occupied.

The at least one sensor used to record the environment data can be or comprise, for example, a camera or an induction loop and/or a magnet geometer and/or a radar sensor and/or a lidar sensor and/or an ultrasonic sensor and/or the like.

In some embodiments, currently occupied or also free parking spaces are each determined using the environment data at least in the part of the area in question.

Based on this and on the mosaic image, and in some embodiments, a hybrid map of at least this part of the area is generated. This hybrid map shows the current occupancy of the parking spaces there, i.e., the current occupancy situation there. The hybrid map is generated in that the parking spaces determined to be currently occupied using the environment data are labeled as such in the mosaic image, i.e., for example, marked or shown or provided with a corresponding overlay or the like. For this purpose, corresponding specified markings or symbols or the like can be overlaid, for example, over the corresponding image parts of the mosaic image. In order to label as such a specific parking space recognized as occupied or as free using the environment data, a corresponding labeling of the representation of exactly this parking space can be overlaid in the mosaic image or can be shown, for example, on or around exactly this representation, i.e., this image part of the mosaic image.

In some embodiments, the hybrid map generated in this way is then provided, i.e., for example, output or displayed or superimposed, for instance on a screen of a corresponding assistance or navigation system or the like, in order to support the vehicle driver.

The hybrid map may show, at least in some areas, a real representation, i.e., a photographic representation of the area in question. The hybrid map thus also may show concrete details of the area in question, such as, for example, irregularities or defects of markings and/or in the pavement of the area and/or curbs and/or equipment or infrastructure elements, such as, for instance, lanterns and/or structures and/or payment machines and/or charging stations and/or benches, and/or the like, as they are actually really present in the area in question and thus may also be visible to the vehicle driver in their environment when looking out of the vehicle to be parked. Such details cannot be shown or represented correctly in a practicable way in conventional schematic map representations. However, these details can serve as recognition features or optical anchor points for the vehicle driver and thus facilitate orientation. The hybrid map thus enables the vehicle driver to associate specific points in the hybrid map with corresponding points in the real environment particularly easily. Using the hybrid map, the vehicle driver can thus particularly easily identify free parking spaces that are recognizable in this map in the real environment, in particular more easily than with conventional, purely abstract maps or those formed from purely generic graphical elements. The vehicle driver can thus then approach, for example, a specific free parking space selected in the hybrid map correspondingly more easily in the real environment in order to park the vehicle there. At the same time, it is made possible for the vehicle driver to find a suitable free parking space particularly quickly when looking at the hybrid map due to a corresponding design of the labelings of the occupied and/or free parking spaces in the hybrid map, for example through generic or abstracted symbols or graphical elements or the like.

Compared, for example, to the use of a simple camera image, the hybrid map also offers the benefit that the real occupancy of the parking spaces is shown correctly in each case and can also be dynamically or flexibly adapted to the current real situation particularly easily and with low effort on the basis of the mosaic image of each area. The mosaic image must therefore be generated, for example, only once for a specific area. This mosaic image generated once can then, however, be used to dynamically generate or adapt the hybrid map displaying the current occupancy in each case. This can be performed for example locally, i.e., for example, by an assistance system of the vehicle to be parked itself. For this purpose, the mosaic image, for example, can be saved therein and the labeling of the parking spaces currently recognized as occupied or free can then each be overlaid over it.

Because the camera images for generating the mosaic image can be recorded over a comparatively long period of time, it can thereby be ensured particularly reliably that the mosaic image can actually be generated such that it shows exclusively free parking spaces, i.e., contains image parts for all parking spaces in each area in an unoccupied, i.e., free state. In addition, when the vehicle should currently be parked, typically as quickly as possible, no connection to a satellite is required, which would then also have to be located above the area in question exactly at this point in time, so corresponding delays and corresponding effort can be avoided.

In some embodiments, an image-processing object recognition method is applied to the camera images to recognize the free parking spaces in them. For this purpose, for example, a classic or, respectively, conventional image processing or object recognition algorithm or a method based on machine learning or computer vision can be applied. In some embodiments in the last case, the camera images can thus be processed, for example, by means of a correspondingly trained artificial neural network or the like. The object recognition method can be applied here, for example, directly to recognize the free parking spaces and/or to recognize parked vehicles and thus to identify occupied parking spaces, and/or to recognize markings of the parking spaces and/or dividers between the parking spaces and/or the like. In this way, the image parts showing free parking spaces can be recognized or, respectively, identified particularly easily and quickly, for example without being dependent on additional external data.

In some embodiments, to recognize the free parking spaces in the camera images, sensor data are also recorded in the area at the respective points in time of recording of said camera images, by means of at least one local sensor that is different from one for recording the camera images. Free and/or occupied parking spaces, i.e., the current occupancy of the parking spaces in the area or, respectively, corresponding occupancy data may then be determined from these sensor data. Based on this, the image parts of the aerial and/or satellite images showing the free parking spaces may then be determined. For example, an environment sensing system of at least one vehicle present in or on the area at the point in time in question can be used as the corresponding local sensor. The infrastructure sensors of the area mentioned elsewhere can also be used, for example. The local sensor may for example not be a camera, i.e., work according to another functional principle. For example, the local sensor may be different from an image sensor. The free parking spaces can thus be recognized particularly reliably, in particular unambiguously. Such a sensor can be or comprise, for example, a radar sensor or a lidar sensor or an ultrasonic sensor or an induction loop or a magnetometer or a pressure or, respectively, load sensor or the like. The camera images, on the one hand, and the corresponding sensor data or the occupancy determined therefrom, i.e., corresponding occupancy data for the area which indicate or, respectively, identify currently occupied parking spaces and/or currently free parking spaces, on the other hand, can then be merged, for example, in a server (apparatus or processor), i.e., for instance a backend or cloud server or data center or the like. There, the mosaic image for the area in question can then be generated on this basis. The embodiments proposed here can enable a particularly accurate and reliable recognition of the free parking spaces. For example, for this purpose corresponding position data for the sensor used, which indicate a position of the sensor used in each case in a specified or fixed coordinate system, for example, can be taken into account. Each mosaic image can thus be generated particularly accurately and particularly reliably or, respectively, actually show only free parking spaces particularly reliably. The embodiments proposed here can be particularly useful in particular when the camera images are or comprise aerial and/or satellite images.

In some embodiments, to show the current occupancy in the hybrid map, a specified symbolic vehicle image is overlaid over those image parts of the mosaic image that correspond to the parking spaces recognized using the environment data as currently occupied, i.e., that show these parking spaces-even in a free state. This means that a standardized or, respectively, uniform, for example stylized or schematic, occupancy symbol, i.e., for instance a symbolic vehicle image or the like, can be overlaid over all of the parking spaces of the area or of the part of the area currently recognized in each case as occupied or, respectively, all corresponding image parts of the mosaic image. Such a symbol or symbolic image can thus display that the corresponding parking space is currently occupied by another vehicle. The currently occupied parking spaces in the hybrid map can thus be recognizable by the vehicle driver particularly quickly and easily and consistently as occupied parking spaces. This means the vehicle driver then does not, for example, has to expend any cognitive effort to recognize or understand otherwise potentially different labelings or representations of various occupied parking spaces. Unnecessary distraction or, respectively, an unnecessary strain on the attention of the vehicle driver can thus also be avoided or reduced, which can benefit traffic safety in the corresponding area.

In some embodiments, to show the current occupancy in the area or the part of the area in the hybrid map, a specified availability symbol or symbolic parking space image is overlaid over those image parts of the mosaic image that correspond to parking spaces recognized using the environment data as currently free, i.e., that show these parking spaces. In other words, all parking spaces currently recognized as free can thus be labeled in the hybrid map with a uniform or standardized, for example stylized or schematic, symbolic parking space image. For a parking lot, such a parking space symbol can be or comprise, for example, a blue area with a white P or, for example, also a white border or the like. The symbolic parking space image can be adapted to the size of the parking space in question, i.e., fill or cover it at least substantially completely. Thus, currently free parking spaces that may be different sizes, for example, can also be uniformly labeled. The labeling of the free parking spaces by a specified symbolic parking space image can enable the vehicle driver to recognize the currently free parking spaces particularly easily, quickly, and intuitively as well as with reduced distraction when viewing the hybrid map.

In some embodiments, to generate the hybrid map, specified, i.e., for example, uniform or standardized, for example stylized or schematic, symbols for specified or, respectively, predefined infrastructure or equipment features of each area are overlaid over the mosaic image in a positionally accurate manner. In other words, such a symbol can be shown in the hybrid map at a point that corresponds to the real point or position at which the infrastructure or equipment feature in question is actually really located in the area in question. Such infrastructure or equipment features can be or comprise for example charging opportunities, i.e., for example, charging connections or charging stations or induction charging loops or the like. Other infrastructure or equipment features in the area can also be represented in the hybrid map by corresponding symbols, such as, for example, payment machines, exits, toilets, shopping opportunities, and/or the like. The symbolic, i.e., schematic or abstracted, representation or labeling proposed here of such infrastructure or equipment features in the hybrid map can enable the vehicle driver to recognize or, respectively, identify such infrastructure or equipment features particularly easily and quickly. This may be the case, for example, since such infrastructure or equipment features, for example when viewed from above, i.e., from the perspective of the aerial or satellite images, look different in different areas or, respectively, designs and take up a relatively small surface area and may thus be difficult to recognize or, respectively, identify in a corresponding image part of an aerial or satellite image.

In some embodiments, a parking space currently recognized as free in the area in question is selected automatically as the target parking space for the vehicle to be parked. An indicator is then displayed on this selected target parking space in the hybrid map. The target parking space can be selected, for example, based on the current position of the vehicle to be parked and/or specified or automatically determined requirements of the vehicle driver for a parking space, for example, with regard to an available charging opportunity and/or sufficient space, for instance, for getting into and out of the vehicle and/or loading or unloading and/or handicap accessibility or the like. Selecting this parking space as the target parking space can be performed automatically, for example, by a corresponding assistance system of the vehicle to be parked, i.e., for instance a corresponding parking assistant or the like. The indicator can emphasize the selected target parking space, for example, compared to other free parking spaces that may be available, for instance by a frame and/or a symbol and/or another color or the like. In the hybrid map, for example, the vehicle to be parked can also be represented at its current position in the hybrid map and a trajectory from this representation of the vehicle to be parked to the selected target parking space can be shown or the like at least as part of the indicator of the selected target parking space. The vehicle driver can thus be even more effectively supported when parking the vehicle.

The teachings herein also relate to a digital hybrid map of an area comprising multiple parking spaces for vehicles or, respectively, for one vehicle each. The map may be stored on a medium, such as for example a memory. The hybrid map, in some embodiments generated according to the methods discussed herein, shows the area as a combination of vehicle-free image parts of camera images of the area and labelings of each of the currently occupied parking spaces and/or each of the currently free parking spaces overlaid over them according to a current occupancy of each of the parking spaces. The hybrid map may thus, for example, be or correspond to the hybrid map mentioned in connection with the methods discussed herein. The hybrid map can be present for example as a digital data set. The hybrid map, i.e., for example, the corresponding data set, may be stored on or in a (computer-readable) data memory. Such a data memory can in some embodiments also be understood as a hybrid map within the context of the teachings herein. The teachings herein also relate to such a computer-readable data memory, on or in which such a digital hybrid map or, respectively, a corresponding data set is stored.

The teachings herein also relate to an assistance system for supporting a vehicle driver when parking a vehicle. The assistance system has an input interface, a data processing apparatus, and an output interface. The input interface and the output interface can be separate from one another or be integrated or combined in a common interface. The input interface and the output interface can each be designed completely or partially in hardware and/or in software. The assistance system may in some embodiments be configured to generate or, for example, via the input interface, to capture a mosaic image of an area comprising multiple parking spaces for vehicles, which is composed of vehicle-free image parts of multiple camera images, in particular recorded at different points in time, of the area. Furthermore, the assistance system may in some embodiments be configured to capture the environment data at least of a part of the area, which characterize or indicate a current occupancy of the parking spaces there. Furthermore, the assistance system may in some embodiments be configured to generate, based on the mosaic image and the current environment data, i.e., the corresponding current occupancy of the parking spaces, a hybrid map, in particular the hybrid map according to the teachings herein, in which the currently occupied parking spaces and/or currently free parking spaces are labeled by appealing overlays over the corresponding image parts of the mosaic image, and to provide said hybrid map to support the vehicle driver when parking the vehicle on or in a free parking space.

The assistance system in some embodiments can thus be, for example, an assistance system or, respectively, controller for a vehicle or be designed as a vehicle-external server (server apparatus), i.e., for instance as a backend or cloud server or data center or the like, or comprise both an assistance system or, respectively, controller for a vehicle and a vehicle-external server apparatus, which are configured for corresponding interaction. The assistance system in some embodiments can thus be designed and configured to, in particular automatically or semi-automatically, perform one or more of the methods or steps according to the teachings herein or a, for example server-side or vehicle-side, part of a method according to the teachings herein.

The teachings herein also relate to a motor vehicle, which is equipped with the assistance system in its embodiment as an assistance system for a vehicle. The motor vehicle may in some embodiments thus, in particular, be or correspond to the vehicle to be parked mentioned herein and/or the hybrid map and/or the assistance system. The assistance system of the motor vehicle may in some embodiments already contain, for example, the premade mosaic image of the area in question in a data memory of the assistance system and/or be configured to capture, i.e., access or receive, the mosaic image from the vehicle-external server apparatus. The motor vehicle may in some embodiments also comprise in particular an output or, respectively, display apparatus, i.e., for instance a screen or a display, for outputting or, respectively, displaying the hybrid map in question. This output or, respectively, display apparatus can be part of the assistance system or be coupled to it. The motor vehicle according to the teachings herein can also have, for example, a sensor system or, respectively, environment sensing system for recording the environment data and/or sensor data mentioned in connection with the discussed methods.

Other features of the invention will be apparent from the following description of the FIGS. in conjunction with the drawings. The features and combinations of features mentioned in the preceding description, as well as the features and combinations of features discussed in the following description and/or just in the figures, can be used not only in the mentioned combination, but also in other combinations or by themselves without departing from the scope of the invention.

Identical or functionally identical elements are provided with the same reference signs in the FIGS. At least in some cases, only a representative selection of identical or similar elements that are present more than once is shown explicitly in the FIGS. for purposes of simplicity.

To support the parking of a vehicle, which is explained in the following using the example of parking a passenger car in a parking area, a top-view map of the corresponding parking area can be useful. However, if a simple aerial or satellite image is used as such a top-view map, this can lead to confusion because the occupancy situation shown therein, i.e., the distribution of other parked vehicles, typically does not correspond to the current on-site reality. It can also be problematic to record the surrounding parking area, for example, by means of a vehicle's front or rear camera that is typical of driver assistance functions today, in order to create the top-view map. Such a vehicle camera typically cannot offer a favorable perspective, for example, cannot look onto roofs of other parked cars. In addition, the top-view map could not be recorded or, respectively, generated instantly for an extended area, but instead would have to be composed of a series of images recorded over time. This can also lead to difficulties, since, for example, dynamic, i.e., moving objects or shadows or the like or those depending on the perspective could potentially be shown multiple times and/or inconsistently in the resulting top-view map.

In the present case, a corresponding top-view map for supporting the parking of a vehicle should therefore be generated which avoids these problems, i.e., for example, is cleared of other already parked vehicles, displays the actual current occupancy or, respectively, occupancy situation, offers a favorable or, respectively, useful perspective, and has no artifacts or as few as possible.

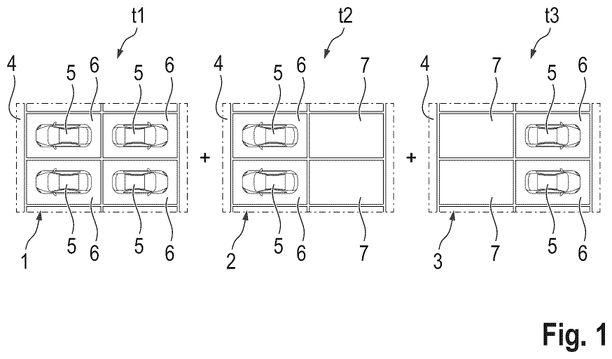

To illustrate a first method step, FIG. 1 shows multiple camera images, which are aerial or satellite images here by way of example. These comprise here a first image 1 that was recorded at a first point in time t1, a second image 2 that was recorded at a second point in time t2, and a third image 3 that was recorded at a third point in time t3. The images 1, 2, 3 show the same parking lot 4, which comprises multiple parking spots. However, the points in time t1, t2, t3 are temporally far enough part from each other that in the meantime the occupancy, i.e., the presence and distribution of parked vehicles 5 in the parking lot 4, has changed. Thus, at point in time t1, all parking spots in the parking lot 4 are occupied by parked vehicles 5, such that exclusively occupied parking spots 6 can be recognized or, respectively, are depicted accordingly in the first image 1. At point in time t2, another occupancy situation is given, in which two parking spots in the parking lot 4 are occupied and two other parking spots in the parking lot 4 are free. Accordingly, two occupied parking spots 6 and two free parking spots 7 in the parking lot 4 can be recognized in the second image 2. This occupancy situation has reversed here at the point in time t3, such that the parking spots 6 that were occupied at the point in time t2 are now free at point in time t3 and vice versa. Accordingly, two occupied parking spots 6 and two free parking spots 7 are now also shown in the third image 3, wherein, compared to the second image 2, however, other parking spots are occupied and free. As shown here schematically by the + sign, these three images 1, 2, 3 recorded at the different points in time t1, t2, t3 can be combined with each other.

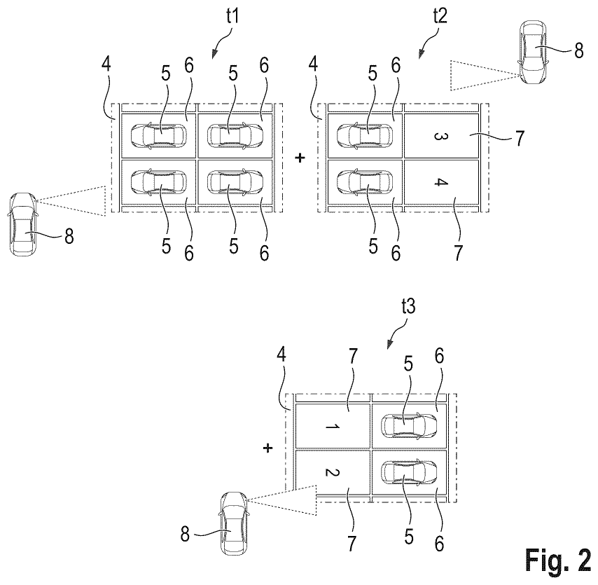

To do so, all image parts that show free parking spots 7 are identified across all recorded images 1, 2, 3. To do so, the images 1, 2, 3, for example, can be processed by means of a corresponding image-processing object recognition method for recognizing the free parking spots 7. The free parking spots 7 can also be detected by sensors locally on site, i.e., in the parking lot 4 itself at each of the points in time t1, t2, t3. This is illustrated schematically and by way of example in FIG. 2. Here, the parking lot 4 is also shown in schematic form at the various in time t1, t2, t3 with the then given different points occupancies. The parking spots in the parking lot 4 are numbered with continuous numbers from 1 to 4 to allow better identification. It can thus be seen that, at point in time t2, by way of example, the parking spots 3 and 4 are free and the remaining parking spots are occupied, while at point in time t3, the parking spots 1 and 2 are free, while the parking spots 3 and 4 are then occupied.

One or more additional vehicles may be located or moving in the parking lot 4 at the various points in time t1, t2, t3, for example, while searching for a free parking spot 7 or when leaving a parking spot or, respectively, the parking lot 4. By way of example, such an additional vehicle is shown here as an observation vehicle 8 at each of the points in time t1, t2, t3. These observation vehicles 8 each have an environment sensing system, which can comprise, for example, a camera and/or a lidar apparatus and/or an ultrasonic sensor or the like. The parked vehicles 5 also indicated schematically here that may be present in the parking lot 4 and/or free parking spots 7 that may be present can be detected, i.e., recognized as such, at the point in time t1, t2, t3 in question. This is indicated here by corresponding schematically indicated detection or view cones of the environment sensing systems extending laterally from the observation vehicles 8.

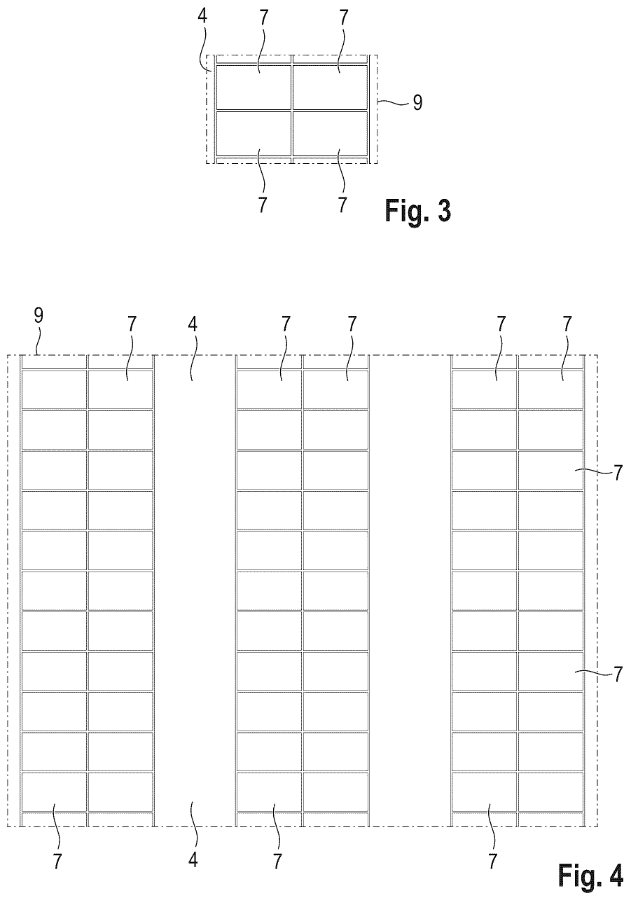

Using corresponding environment data recorded by the observation vehicles 8, it can be determined which of the parking spots in the parking lot 4 are free parking spots 7 at the point in time t1, t2, t3 in question. Corresponding environment or occupancy data can be combined with the images 1, 2, 3 shown in FIG. 1. As a result, a mosaic image 9 of the parking lot 4 is shown in FIG. 3. This is composed of those image parts of the images 1, 2, 3 that show free parking spots 7. The mosaic image 9 thus shows the parking lot 4 completely, but exclusively with free parking spots 7, i.e., effectively cleared of the parked vehicles 5 depicted in the images 1, 2, 3.

For further illustration, FIG. 4 shows an additional such mosaic image 9 of a larger parking lot 4, which comprises a plurality of parking spots. These are also all shown here as free parking spots 7.

Such a mosaic image 9 can then serve in each case as a starting basis for generating a top-view map of the parking lot 4 in question for a concrete support of a vehicle driver when parking a vehicle in the parking lot 4 in question.

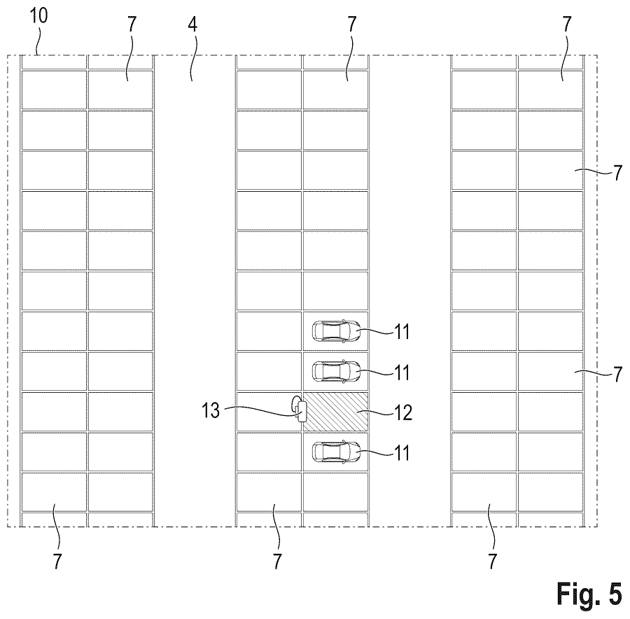

To this end, FIG. 5 shows a corresponding top-view map in the form of a hybrid map 10 of the parking lot 4 also shown in FIG. 4. This hybrid map 10 is generated, for example, in that, when a vehicle should be parked in the parking lot 4, the current occupancy or, respectively, occupancy situation given at that time is determined and, corresponding thereto, corresponding labelings or symbols are overlaid over the corresponding image parts of the mosaic image 9. By way of example, the hybrid map 10 here accordingly contains multiple vehicle symbols 11, which are overlaid over parking spots recognized as occupied at the current point in time in question, and a parking symbol 12, which is overlaid over a parking spot recognized as free at the current point in time in question. In addition, the hybrid map 10 here also contains, by way of example, a charging station symbol 13, which is superimposed at a point at which a charging station is located in the real parking lot 4. The corresponding overlays, i.e., in this case, by way of example, the vehicle symbols 11, the parking symbol 12, and the charging station symbol 13, are shown or, respectively, superimposed, i.e., overlaid over the mosaic image 9, here, by way of example, only in one part of the parking lot 4 or, respectively, the hybrid map 10. This part of the parking lot 4 can correspond, for example, to a part of the parking lot 4 that can be captured at the point in time in question by means of an environment sensing system of the vehicle to be parked. Depending on the available data, more of the areas shown here as free parking spots 7 outside of this part can also be labeled accordingly by overlays or symbols.

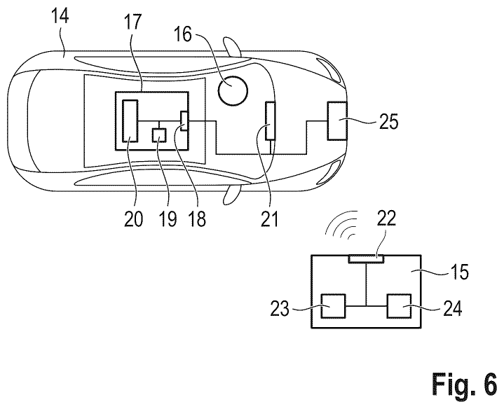

For further illustration, FIG. 6 shows a schematic overview with a motor vehicle 14 and a vehicle-external server apparatus 15. The motor vehicle 14 can be in particular the mentioned vehicle to be parked in the parking lot 4. The motor vehicle 14 can also function—at the same time and/or at other points in time—as one of the observation vehicles 8.

The motor vehicle 14 is controlled here, for example, by a driver 16, who should be supported when parking the motor vehicle 14 in a currently free parking spot 7 of the parking lot 4. For this purpose, the motor vehicle 14 has a corresponding assistance system 17. This is represented here schematically with an interface 18, a processor 19, and a data memory 20. The motor vehicle 14 also has a display apparatus 21, i.e., for example, a screen, in order to display the hybrid map 10 generated in each case, i.e., to output or provide it for the driver 16.

The mosaic image 9 on which each hybrid map 10 is based can be generated, for example, by the server apparatus 15 and sent to the motor vehicle 14 or, respectively, its assistance system 17 or, respectively, be accessed by the assistance system 17 from the server apparatus 15. For this purpose, the server apparatus 15 has, indicated schematically here, a server interface 22, a server processor 23, and a server data memory 24. Via the server interface 22, the server apparatus 15 can capture camera images, in particular aerial and/or satellite images or images from a vehicle or surveillance camera, in this case, for example, the images 1, 2, 3, or also environment data corresponding to each case, which indicate or characterize the occupancy or, respectively, occupancy situation in each case. The server apparatus 15 can then generate the mosaic image 9 in question, in particular automatically. In different versions of the method, each hybrid map 10 can be generated, for example, by the server apparatus 15 or by the motor vehicle 14 or, respectively, its assistance system 17.

The occupancy or, respectively, occupancy situation given when the motor vehicle 14 is located in the parking lot 4 and should be parked can then be determined using the sensor data recorded at that time. These can be recorded, for example, by means of sensors in the parking lot 4 itself and/or from the motor vehicle 14 by means of a vehicle sensor system 25. These sensor data can be captured, for example, by the server apparatus 15 via the server interface 22 in order to determine at which points corresponding symbols, in this case, for example, the vehicle symbols 11, the parking symbol 12, and the charging station symbol 13, should be superimposed, i.e., overlaid over the underlying mosaic image 9. The sensor data can also be captured, for example, by the assistance system 17 via its interface 18. Based on this and based on the mosaic image 9 also accessed, for example, by the server apparatus 15 via the interface 18 or already stored in the data memory 20, the assistance system 17 can then generate the hybrid map 10 in each case. This can then be output to the display apparatus 21, for example also via the interface 18. This can be performed, for example, in each case in response to an automatic recognition of a desire to park by the driver 16 or an activation of a corresponding parking support mode, for example, by a corresponding operational action by the driver 16.

Based on the hybrid map 10 displayed in this way, the driver 16 can then select, for example, a parking spot to park the motor vehicle 14. The assistance system 17, for example, can also select a free parking spot 7 and propose it as the target parking spot, i.e., target parking space, and, for example, label it accordingly in the hybrid map 10. A free parking spot 7 can be labeled here as the selected target parking spot, for example, by the parking symbol 12.

Overall, the examples described show how a visualization map for a parking assistance system that offers or, respectively, enables improved support can be generated and used.

### LIST OF REFERENCE NUMERALS

1 First image
2 Second image
3 Third image
4 Parking lot
5 Parked vehicles
6 Occupied parking spot
7 Free parking spot
8 Observation vehicles
9 Mosaic image
10 Hybrid map
11 Vehicle symbol
12 Parking symbol
13 Charging station symbol
14 Motor vehicle
115 Server apparatus
16 Driver
17 Assistance system
18 Interface
19 Processor
20 Data memory
21 Display apparatus
22 Server interface
23 Server processor
24 Server data memory
25 Sensor system
t1 First point in time
t2 Second point in time
t3 Third point in time

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for supporting a vehicle driver when parking a vehicle in a parking space that is located in an area with multiple such parking spaces, comprising:
recording multiple camera images of the area at various points in time with different occupancies of the parking spaces by vehicles in a period of time temporally before the parking;
combining, from these camera images, those image parts that show free parking spaces to form a mosaic image of the area showing the entire area with exclusively free parking spaces;
when the vehicle is located in the area for parking, recording environment data of at least one part of the area next to the vehicle, which data characterize a current occupancy of the parking spaces there in each case, using a sensor;
determining, using the environment data, currently occupied parking spaces at least in this part of the area;
generating a hybrid map of at least this part of the area, which shows the current occupancy of the parking spaces, wherein the parking spaces determined as currently occupied using the environment data are labeled as such in the mosaic image; and
providing the hybrid map to support the vehicle driver.

2. The method of claim 1, wherein, to recognize the free parking spaces in the camera images, an image-processing object recognition method is applied to the images.

3. The method of claim 1, wherein, to recognize the free parking spaces in the camera images, sensor data are also recorded in the area at the respective points in time of recording of said camera images using a local sensor that is different from a camera used to record the camera images, and free parking spaces and/or occupied parking spaces are determined therefrom, and, based thereon, image parts of the aerial and/or satellite images showing the free parking spaces are determined.

4. The method of claim 1, wherein, to show the current occupancy in the hybrid map, a specified symbolic vehicle image is overlaid in each case over the image parts of the mosaic image corresponding to the parking spaces recognized as currently occupied using the environment data.

5. The method of claim 1, wherein, to show the current occupancy in the hybrid map, a specified symbolic parking space image is overlaid in each case over the image parts of the mosaic image corresponding to parking spaces recognized as currently free using the environment data.

6. The method of claim 1, wherein, to generate the hybrid map, specified symbols for specified equipment features are also overlaid in a positionally accurate manner over the mosaic image.

7. The method of claim 1, wherein a currently free parking space is selected automatically as the target parking space and is displayed in the hybrid map with an indicator of this selected target parking space.

8. A non-transitory medium with a digital hybrid map of an area comprising multiple parking spaces for vehicles, wherein the hybrid map shows the area as a combination of vehicle-free image parts of camera images of the area and labelings of each of the currently occupied parking spaces and/or each of the currently free parking spaces overlaid according to a current occupancy of each of the parking spaces.

9. An assistance system for supporting a vehicle driver when parking a vehicle, having an input interface, a data processor, and an output interface, wherein the assistance system is configured:
to generate or capture a mosaic image of an area that comprises multiple parking spaces for vehicles and is composed of vehicle-free image parts of multiple camera images of the area;
to capture environment data of at least one part of the that characterize a current occupancy of the parking spaces there; and
based on the mosaic image and the current environment data, to generate a hybrid map in which currently occupied parking spaces and/or currently free parking spaces are labeled by corresponding overlays of the corresponding image parts of the mosaic image, and to provide said hybrid map to support the vehicle driver.

10. A motor vehicle having an assistance system of claim 9.

11. The assistance system of claim 9, configured to recognize the free parking spaces in the camera images by applying an image-processing object recognition method to the images.

12. The assistance system of claim 9, configured
to recognize the free parking spaces in the camera images by recording sensor data in the area at the respective points in time of recording of said camera images using a local sensor that is different from a camera used to record the camera images;
to determine free parking spaces and/or occupied parking spaces therefrom, and, based thereon;
to determine image parts of the aerial and/or satellite images showing the free parking spaces.

13. The assistance system of claim 9, configured to show the current occupancy in the hybrid map by overlaying a specified symbolic vehicle image in each case over the image parts of the mosaic image corresponding to the parking spaces recognized as currently occupied using the environment data.

14. The assistance system of claim 9, configured to show the current occupancy in the hybrid map by overlaying a specified symbolic parking space image in each case over the image parts of the mosaic image corresponding to parking spaces recognized as currently free using the environment data.

15. The assistance system of claim 9, configured to generate the hybrid map by overlaying specified symbols for specified equipment features in a positionally accurate manner over the mosaic image.

16. The assistance system of claim 9, configured to automatically select a currently free parking space as the target parking space and to display an indicator of this selected target parking space in the hybrid map.
